(19) United States
(12) Patent Application Publication
(10) Pub. No.: US 2023/0230137 A1
(43) Pub. Date: Jul. 20, 2023

(54) STORE COOPERATION SUPPORT APPARATUS, SYSTEM, METHOD, AND COMPUTER READABLE MEDIUM

(71) Applicant: NEC Corporation, Minato-ku, Tokyo (JP)

(72) Inventor: Kazutaka SAMPEI, Tokyo (JP)

(73) Assignee: NEC Corporation, Minato-ku, Tokyo (JP)

(21) Appl. No.: 18/029,721

(22) PCT Filed: Oct. 13, 2020
(86) PCT No.: PCT/JP2020/038604

§ 371 Date: Mar. 31, 2023

(51) Int. Cl. G06Q 30/0601; G06Q 30/02; G06Q 10/1093

(52) U.S. Cl. CPC G06Q 30/0601; G06Q 30/0281; G06Q 10/1095

(57) ABSTRACT

A store cooperation support apparatus (1) according to the present invention includes: an acquisition unit (11) that acquires, through a sales site of a first store (an online store 2) capable of selling a predetermined product online, a trial request including date and time information indicating a date and time at which a predetermined customer wants to try the product in a physical store; and a setting unit (12) that sets a disclosure period for disclosing, based on the date and time information, disclosure information including interest information of the customer about the product in the first store to a second store (a physical store 4 or 5) capable of physically selling the product.

### TECHNICAL FIELD

The present invention relates to a store cooperation support apparatus, a system, a method, and a computer readable medium, and in particular, to a store cooperation support apparatus, a system, a method, and a computer readable medium for supporting cooperation between an online store and a physical store.

### BACKGROUND ART

An online store can easily obtain interest information of a user about products by allowing the user to freely view product information. However, an online store cannot provide opportunities for trying products so as to motivate purchases. Further, a physical store can easily provide, in person, opportunities for trying products so as to motivate purchases. However, a physical store provides few opportunities for acquiring interest information about products.

Patent Literature 1 discloses a technology related to a purchase-related information management system. In the system disclosed in Patent Literature 1, the purchase histories of a specific customer in an online store and a physical store are centrally managed by an online server. Further, a terminal in the physical store can view purchase-related information about the customer by accessing an online server.

### CITATION LIST

### Patent Literature

Patent Literature 1: Japanese Unexamined Patent Application Publication No. 2014-085718

### SUMMARY OF INVENTION

### Technical Problem

However, when the business operator of the online store is not the same as the business operator of the physical store, one business operator may express a concern about continuation of the sharing of the purchase history with the other business operator in regard to managing customer information. For example, there are concerns in regard to security issues and protecting personal information of customers.

The present disclosure has been made to solve the above-described problem and an object thereof is to provide a store cooperation support apparatus, a system, a method, and a program for appropriately managing customer information when cooperation between an online store and a physical store is performed.

### Solution to Problem

A store cooperation support apparatus according to a first example aspect of the present disclosure includes:

acquisition means for acquiring, through a sales site of a first store capable of selling a predetermined product online, a trial request including date and time information indicating a date and time at which a predetermined customer wants to try the product in a physical store; and

setting means for setting a disclosure period for disclosing, based on the date and time information, disclosure information including interest information of the customer about the product in the first store to a second store capable of physically selling the product.

A store cooperation support system according to a second example aspect of the present disclosure includes:

a first store server configured to provide a sales site of a first store capable of selling a predetermined product online;

a store terminal in a second store capable of physically selling the product; and

a store cooperation support apparatus, in which

the store cooperation support apparatus includes:

acquisition means for acquiring, through the sales site, a trial request including date and time information indicating a date and time at which a predetermined customer wants to try the product in a physical store; and

setting means for setting a disclosure period for disclosing, based on the date and time information, disclosure information including interest information of the customer about the product in the first store to the store terminal in the second store.

A store cooperation support method according to a third example aspect of the present disclosure includes:

acquiring by a computer, through a sales site of a first store capable of selling a predetermined product online, a trial request including date and time information indicating a date and time at which a predetermined customer wants to try the product in a physical store; and

setting by the computer a disclosure period for disclosing, based on the date and time information, disclosure information including interest information of the customer about the product in the first store to a second store capable of physically selling the product.

A non-transitory computer readable medium storing a store cooperation support program according to a fourth example aspect of the present disclosure causes a computer to execute:

an acquisition process of acquiring, through a sales site of a first store capable of selling a predetermined product online, a trial request including date and time information indicating a date and time at which a predetermined customer wants to try the product in a physical store; and

a setting process of setting a disclosure period for disclosing, based on the date and time information, disclosure information including interest information of the customer about the product in the first store to a second store capable of physically selling the product.

### Advantageous Effects of Invention

According to the present disclosure, it is possible to provide a store cooperation support apparatus, a system, a method, and a program for appropriately managing customer information when cooperation between an online store and a physical store is performed.

### BRIEF DESCRIPTION OF DRAWINGS

FIG. 1 is a block diagram showing a configuration of a store cooperation support apparatus according to a first example embodiment;

FIG. 2 is a flowchart showing a flow of a store cooperation support method according to the first example embodiment;

FIG. 3 is a block diagram showing an overall configuration of a store cooperation support system according to a second example embodiment;

FIG. 4 is a block diagram showing a configuration of a store cooperation support apparatus according to the second example embodiment;

FIG. 5 is a sequence diagram showing a flow of trial reservation processing according to the second example embodiment;

FIG. 6 is a flowchart showing a flow of processing for disclosing disclosure information according to the second example embodiment;

FIG. 7 is a flowchart showing a flow of processing performed by a store when a customer who has made a trial reservation visits the store according to the second example embodiment;

FIG. 8 is a flowchart showing a flow of processing for updating integrated ID information when a customer visits a store according to the second example embodiment; and

FIG. 9 is a flowchart showing a flow of processing for disclosing a sales history according to the second example embodiment.

### EXAMPLE EMBODIMENT

Example embodiments according to the present disclosure will be described hereinafter in detail with reference to the drawings. The same or corresponding elements are denoted by the same reference symbols throughout the drawings, and redundant descriptions will be omitted as necessary for the clarification of the description.

### <First Example Embodiment>

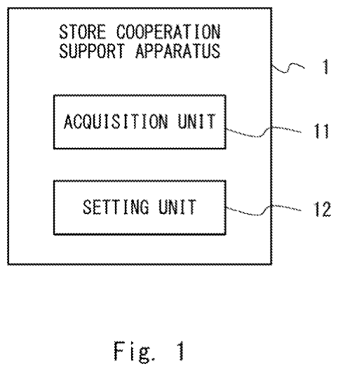

FIG. 1 is a block diagram showing a configuration of a store cooperation support apparatus 1 according to a first example embodiment. The store cooperation support apparatus 1 is an information processing apparatus for supporting cooperation between a first store capable of selling a predetermined product online and a second store capable of physically selling this product. The store cooperation support apparatus 1 is connected through a network (not shown) to an online store server (not shown) by which the first store conducts online sales and a store terminal (not shown) installed in the second store. Further, the online store server can be connected to a user terminal (not shown) operated by a predetermined customer. The user terminal transmits a trial request for a predetermined product in a physical store to the online store server in response to an operation by the customer. Note that the trial request includes date and time information indicating the date and time at which the customer wants to try the product in the physical store.

The store cooperation support apparatus 1 includes an acquisition unit 11 and a setting unit 12. The acquisition unit 11 acquires a trial request including date and time information indicating the date and time at which a predetermined customer wants to try a predetermined product in the physical store through a sales site of the first store. For example, the acquisition unit 11 receives a trial request from a user terminal through an online store server.

The setting unit 12 sets a disclosure period for disclosing, to the second store, disclosure information including interest information of the customer about the product in the first store based on the date and time information. Note that the interest information is information indicating the preferences and the interest of the customer in regard to a target product. Specifically, the interest information is information indicating a brand, a size, a color, and the like of the product. The interest information may be specified, for example, by analyzing an action history (a viewing and search history) of a user on the sales site of the first store. Further, the disclosure period includes the date and time indicated by the date and time information included in the trial request, and the date and time includes at least a time limit of the disclosure. For example, the disclosure period may be from the date and time of receipt of the trial request to a few hours after the date and time at which a user wants to try a product indicated by the date and time information. Further, the date and time information may be information indicating a period during which a user wants to try a product. In this case, the time limit of the disclosure period may be a time limit of the period indicated by the date and time information.

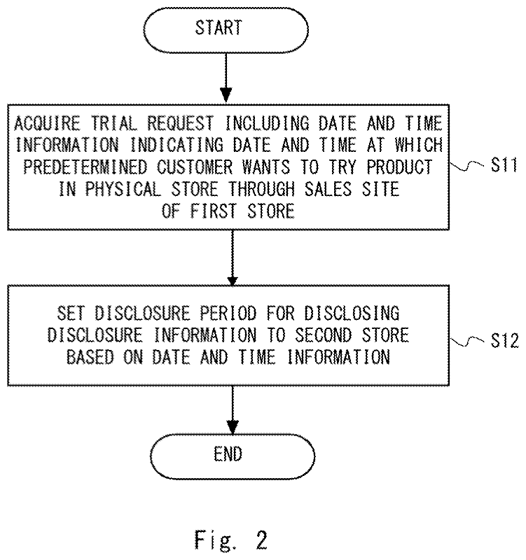

FIG. 2 is a flowchart showing a flow of a store cooperation support method according to the first example embodiment. First, the acquisition unit 11 acquires a trial request including date and time information indicating the date and time at which a predetermined customer wants to try a product in the physical store through a sales site of the first store (S11). Next, the setting unit 12 sets a disclosure period for disclosing, to the second store, disclosure information including interest information of the customer about the product in the first store based on the date and time information (S12).

Accordingly, when the store cooperation support apparatus 1 receives, after that, a disclosure request for disclosure information (i.e., a request for disclosure of disclosure information) of the above customer from a store terminal of the second store within the disclosure period, the store cooperation support apparatus 1 discloses the disclosure information to the store terminal. On the other hand, when the store cooperation support apparatus 1 receives the disclosure request from the store terminal of the second store outside the disclosure period, the store cooperation support apparatus 1 prevents the disclosure of the disclosure information of the above customer. Therefore, for example, when a customer who has made a trial request actually visits the second store at the specified date and time indicated by the date and time information, a store clerk of the second store can have interest information included in the disclosure information and then provide an appropriate service to the customer. Alternatively, since a store clerk of the second store can refer to the disclosure information prior to the customer's visit within the disclosure period, the store clerk can have interest information of the customer who plans to visit the store. On the other hand, since the disclosure information is not disclosed outside the disclosure period, customer information of an online store such as interest information of the customer is not disclosed more than necessary. Therefore, it is possible to appropriately manage customer information when cooperation between an online store and a physical store is performed.

Note that the store cooperation support apparatus 1 includes, as a configuration that is not shown, a processor, a memory, and a storage device. Further, a computer program in which processes of an entry control method according to this example embodiment are implemented is stored in the storage device. Further, the processor loads the computer program from the storage device into the memory and executes the loaded computer program. In this way, the processor implements the functions of the acquisition unit 11 and the setting unit 12.

Alternatively, each of the acquisition unit 11 and the setting unit 12 may be implemented by dedicated hardware. Further, some or all of the components of each apparatus may be implemented by a general-purpose or dedicated circuit (circuitry), a processor or the like, or a combination thereof. They may be formed of a single chip, or may be formed of a plurality of chips connected to each other through a bus. Some or all of the components of each apparatus may be implemented by a combination of the above-described circuit or the like and a program. Further, as the processor, a Central Processing Unit (CPU), a Graphics Processing Unit (GPU), a field-programmable gate array (FPGA), a quantum processor (a quantum computer control chip), or the like may be used.

Further, when some or all of the components of the store cooperation support apparatus 1 are implemented by a plurality of information processing apparatuses, circuits, or the like, the plurality of information processing apparatuses, circuits, or the like may be disposed in one place in a centralized manner or arranged in a distributed manner. For example, the information processing apparatuses, the circuits, or the like may be implemented as a form in which the information processing apparatuses, the circuits, or the like are connected to each other through a communication network, such as a client server system, a cloud computing system, or the like. Further, the functions of the store cooperation support apparatus 1 may be provided in the form of Software as a Service (SaaS).

### <Second Example Embodiment>

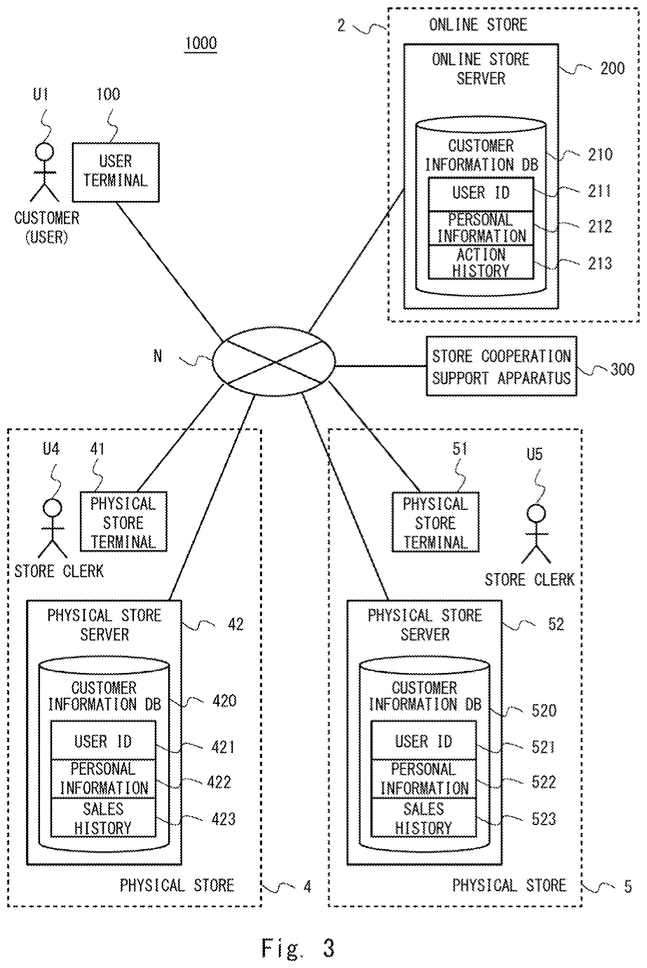

A second example embodiment is a specific example of the first example embodiment described above. FIG. 3 is a block diagram showing an overall configuration of a store cooperation support system 1000 according to the second example embodiment. The store cooperation support system 1000 is an information system for supporting cooperation between an online store 2 capable of selling a specific product online and one or more physical stores 4 (, 5, etc.) capable of physically selling this product. Further, the store cooperation support system 1000 may support cooperation between/among two or more online stores and physical stores, each of which can sell a plurality of products. Cooperation support includes, for example, support for taking a customer U1 of the online store 2 to the physical store 4 or 5 in order for the customer U1 to try a product. At this time, interest information of the customer U1 about the product and personal information of the customer U1 in the online store 2 are disclosed to the physical store after a disclosure period is set. Cooperation support further includes, for example, disclosing a sales history and the like of the customer U1 to the online store 2 when the customer U1 who has been taken to the physical store has purchased a product in the physical store. The store cooperation support system 1000, for example, appropriately shares customer information with both online and physical stores, thereby supporting cooperation between the stores.

The store cooperation support system 1000 includes a user terminal 100, an online store server 200, a store cooperation support apparatus 300, a physical store terminal 41, a physical store server 42, a physical store terminal 51, and a physical store server 52. The user terminal 100, the online store server 200, the store cooperation support apparatus 300, the physical store terminal 41 and the physical store server 42, and the physical store terminal 51 and the physical store server 52 are connected to one another through a network N so that they can communicate with one another. Note that the network N is a wired or wireless communication line.

The user terminal 100 is an information processing terminal operated by the customer U1. The user terminal 100 is, for example, a mobile phone terminal, a smartphone, a tablet terminal, and a Personal Computer (PC). In response to an operation performed by the customer U1, the user terminal 100, for example, searches, views, and purchases a product through the sales site provided by the online store server 200. Further, the user terminal 100 receives an input of the product specified by the customer U1 and date and time information indicating the date and time at which the customer U1 wants to try the product, and transmits a trial request including information about the product and the date and time information to the online store server 200. Further, when a reservation of a physical store where the customer U1 can try the product is made by the store cooperation support apparatus 300 in response to the trial request, the user terminal 100 receives a notification of a trial reservation from the store cooperation support apparatus 300 or the online store server 200. The notification of a trial reservation is information including, for example, information about the product for which a trial reservation has been made, information about the physical store where the customer U1 can try the product, and date and time information indicating the date and time of the reserved trial. The notification of a trial reservation may be, for example, a notification sent by e-mail etc.

The online store server 200 is a server apparatus by which the online store 2 that sells one or more products online provides a Web site as a sales site. The online store server 200 includes a customer information DB 210 in addition to a general function of selling products online. However, the customer information DB 210 may be stored in another storage device connected to the online store server 200. The customer information DB 210 associates a user ID 211, personal information 212, and an action history 213 with one another and stores them. The user ID 211 is identification information of the customer U1 etc., who is a user of the online store 2. The personal information 212 is personal information of a customer corresponding to the user ID 211. The personal information 212 is, for example, name, date of birth, gender, contact information, height, and weight. The action history 213 is history information about a search, viewing, and the like performed on the sales site by the customer corresponding to the user ID 211. Note that the customer information DB 210 may associate interest information of the customer about a specific product with the user ID 211. The interest information, as described above, is information indicating the preferences and the interest of the customer in regard to a target product. Specifically, the interest information is information indicating a brand, a size, a color, and the like of the product. Therefore, the online store server 200 may analyze the action history 213 in the customer information DB 210 at a predetermined timing, generate interest information of the customer corresponding to the user ID 211, and register it in the customer information DB 210. Note that the online store server 200 may take into account the height and weight included in the personal information 212 when it generates the interest information.

Further, when the online store server 200 according to the second example embodiment receives a trial request from the user terminal 100 logged in by the user ID, it transmits the trial request to the store cooperation support apparatus 300. At this time, the online store server 200 includes, in the trial request, the

ID of the online store 2, the user ID of a request source, information about the product which the customer wants to try, and date and time information indicating the date and time at which the customer wants to try the product.

The physical stores 4 and 5 are a group of stores capable of selling products equivalent to those sold online by the above-described online store 2. Note that the number of physical stores may be any number greater than or equal to one. Further, each of the physical stores 4 and 5 may operate an online store. Further, the online store 2 and the physical stores 4 and 5 may be operated by different entities. Alternatively, the online store 2 and the physical stores 4 and 5 may be operated by the same entity. In this case, for example, the physical stores 4 and 5 may be branch stores of the same department store, and the online store 2 may be an Electric Commerce (EC) site of this department store. Note that the online store 2 may be a portal site of the EC site.

The physical store 4 includes the physical store terminal 41 and the physical store server 42. The physical store terminal 41 is a cash register terminal or the like installed in the physical store 4 and operated by a store clerk U4. The physical store terminal 41 may receive a notification of a trial reservation from the store cooperation support apparatus 300. Alternatively, the physical store terminal 41 may confirm a notification of a trial reservation from the store cooperation support apparatus 300 through the physical store server 42. Further, the physical store terminal 41 transmits a disclosure request for disclosure information about the customer who has made a trial reservation to the store cooperation support apparatus 300, receives the disclosure information from the store cooperation support apparatus 300 if it is within a disclosure period, and displays the received disclosure information on the screen (not shown).

The physical store terminal 41 can perform payment processing of the product in response to an operation performed by the store clerk U4. When the customer U1 who has made a trial reservation has visited the store and has purchased (made a payment for) the product which the customer U1 has tried, the physical store terminal 41 transmits a payment notification (through the physical store server 42 if necessary) to the store cooperation support apparatus 300.

When doing so, the physical store terminal 41 may include a payment history (a sales history) in the payment notification. At this time, the physical store terminal 41 may associate the sales history corresponding to the payment processing with a user ID of the customer who has purchased the product and store them in a customer information DB 420 described later. The physical store terminal 41 may also transmit a specification of a disclosure range of the sales history to the store cooperation support apparatus 300.

The physical store server 42 is a server apparatus for managing customer information, inventory information (not shown) of products, and the like in the physical store 4. Note that the physical store server 42 may be installed in a data center or the like outside the physical store 4. The physical store server 42 includes the customer information DB 420. The customer information DB 420 associates a user ID 421, personal information 422, and a sales history 423 with one another and stores them. The user ID 421 is identification information of a customer of the physical store 4. The personal information 422 is personal information of a customer corresponding to the user ID 421. The sales history 423 is a sales history of a product regarding the customer corresponding to the user ID 421. The sales history 423 includes, for example, information about a product sold, the amount of payment for the product sold, credit card information used for making the payment, and the like.

Further, the physical store server 42 according to the second example embodiment registers inventory information about products in the physical store 4 to the store cooperation support apparatus 300. However, the present disclosure is not limited thereto. For example, the physical store server 42 may retain inventory information about products and send the inventory information in response to a query from the store cooperation support apparatus 300.

The physical store 5 includes the physical store terminal 51 and the physical store server 52. The physical store terminal 51 is a cash register terminal or the like installed in the physical store 5 and operated by a store clerk U5. The functions and the configurations of the physical store terminal 51 are similar to those of the physical store terminal 41 described above.

Further, the physical store server 52 is a server apparatus for managing customer information, inventory information (not shown) of products, and the like in the physical store 5. Note that the physical store server 52 may be installed in a data center or the like outside the physical store 5. The physical store server 52 includes a customer information DB 520. The customer information DB 520 associates a user ID 521, personal information 522, and a sales history 523 with one another and stores them. The functions and the configurations of the physical store server 52 are similar to those of the physical store server 52 described above.

The store cooperation support apparatus 300 is an example of the store cooperation support apparatus 1 described above. The store cooperation support apparatus 300 is an information processing apparatus for supporting cooperation among the online store 2 and the physical stores 4 and 5. The store cooperation support apparatus 300 may be redundant in a plurality of servers, and each functional block may be implemented by a plurality of computers.

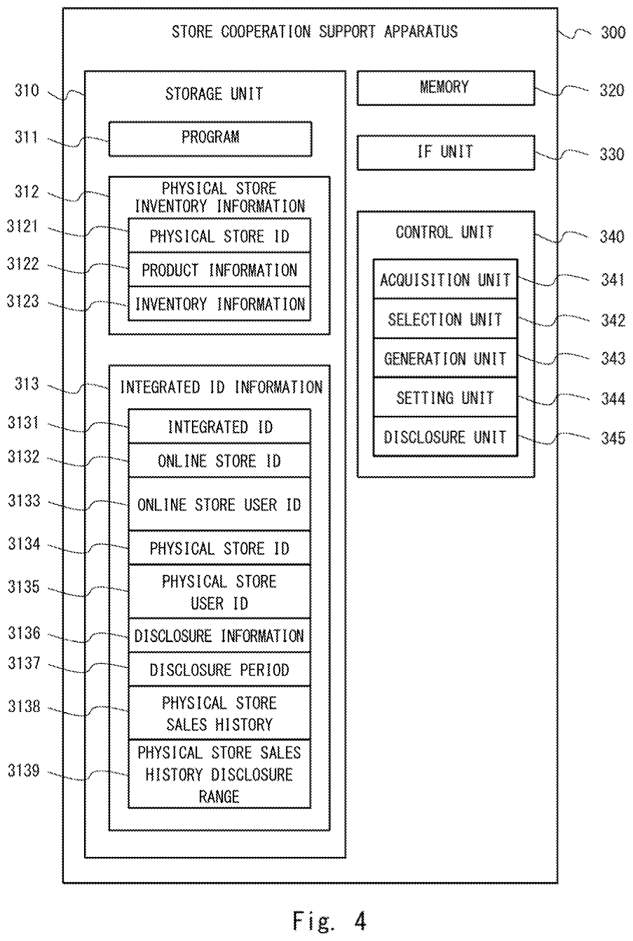

FIG. 4 is a block diagram showing a configuration of the store cooperation support apparatus 300 according to the second example embodiment. The store cooperation support apparatus 300 includes a storage unit 310, a memory 320, an InterFace (IF) unit 330, and a control unit 340. The storage unit 310 is an example of a storage device such as a hard disk or a flash memory. The storage unit 310 stores a program 311, physical store inventory information 312, and integrated ID information 313. The program 311 is a computer program in which processing (trial reservation processing, processing for disclosing disclosure information, processing for updating integrated ID information, processing for disclosing a sales history, etc.) of a store cooperation method according to the second example embodiment is implemented.

The physical store inventory information 312 is information for managing the inventory of each product in the respective physical stores. The physical store inventory information 312 is information that associates a physical store ID 3121, product information 3122, and inventory information 3123 with one another. The physical store ID 3121 is identification information of the physical store. The product information 3122 is information about a product that is physically sold in a corresponding physical store. The product information 3122 includes, for example, information such as a product ID, a product name, attributes (a brand, a color, a size) of a product, a price, and the like. The inventory information 3123 is information indicating the number of inventory products etc. in the corresponding physical store.

The integrated ID information 313 is information managed by associating the online store with the physical store for which a trial reservation of the product has been made. In the integrated ID information 313, at least an integrated ID 3131, an online store ID 3132, a physical store ID 3134, disclosure information 3136, and a disclosure period 3137 are associated with one another. Further, in the integrated ID information 313, an online store user ID 3133 may be associated with the integrated ID 3131. Further, in the integrated ID information 313, a physical store user ID 3135 may be associated with the integrated ID 3131 after the customer has tried the product at the physical store and then paid for the product. Further, in the integrated ID information 313, a physical store sales history 3138 and a physical store sales history disclosure range 3139 may be associated with the integrated ID 3131.

The integrated ID 3131 is at least identification information of a trial request (a trial reservation) of a product. Further, the integrated ID 3131 may be identification information of a set of the customer U1 of the online store 2 and the physical store (4 or 5) for which a trial reservation has been made. The online store ID 3132 is identification information of the online store. The online store user ID 3133 is identification information of a customer (a user) in the associated online store ID 3132. For example, the online store user ID 3133 corresponds to the user ID 211 described above. The physical store ID 3134 is identification information of the physical store. The physical store user ID 3135 is identification information of a customer (a user) in the associated physical store ID 3134. Note that the physical store user ID 3135 may be issued at the physical store, and in this case, for example, it corresponds to the user ID 421 or the user ID 521 described above. Alternatively, the physical store user ID 3135 may be an ID issued independently by the store cooperation support apparatus 300.

The disclosure information 3136 is information including (at least part of) the personal information 212 and interest information of the customer in the corresponding online store. The interest information is information which is obtained by analyzing the aforementioned action history 213 and which indicates the interests, the preferences, and the like of the customer regarding the product which the customer wants to try.

The disclosure period 3137 is information in which a period during which disclosure of the disclosure information 3136 to the corresponding physical store is permitted is defined. In the disclosure period 3137, at least the date and time of a time limit for permitting disclosure is defined. However, in the disclosure period 3137, the time limit may be defined as being indefinite. Further, the disclosure period 3137 may include an invalid flag indicating that disclosure of the disclosure information 3136 is not permitted.

The physical store sales history 3138 is a sales history of a product regarding a corresponding customer in a corresponding physical store. The physical store sales history 3138 may include a sales history of not only a product which is a trial target but also a product which is not a trial target. The physical store sales history 3138 may also include another sales history in the physical store regarding the corresponding customer.

The physical store sales history disclosure range 3139 is an example of disclosure restriction information. The physical store sales history disclosure range 3139 is information in which a range of information in the corresponding physical store sales history 3138 within which the disclosure specified by the corresponding physical store is permitted or is not permitted is defined.

The memory 320, which is a volatile storage device such as a Random Access Memory (RAM), is a storage area for temporarily holding information when the control unit 340 is operated. The IF unit 330 is a communication interface with the network N.

The control unit 340 is a processor that controls each component of the store cooperation support apparatus 300, namely, a control apparatus. The control unit 340 loads the program 311 from the storage unit 310 into the memory 320 and executes the loaded program 311. In this way, the control unit 340 implements the functions of an acquisition unit 341, a selection unit 342, a generation unit 343, a setting unit 344, and a disclosure unit 345.

The acquisition unit 341 is an example of the acquisition unit 11 described above. The acquisition unit 341 acquires a trial request for the product by the customer U1 from the user terminal 100 through the online store server 200. Note that the trial request includes the online store ID of the online store 2 corresponding to the online store server 200, the user ID of the customer U1 who has made the trial request, information about the product which the customer U1 wants to try, and date and time information indicating the date and time at which the customer U1 wants to try the product.

Further, in response to the trial request, the acquisition unit 341 acquires, from the online store server 200, the personal information 212 of the customer U1 in the online store 2 and interest information of the customer U1 regarding the information about the product which the customer U1 wants to try. Alternatively, instead of acquiring the interest information of the customer U1 from the online store server 200, the acquisition unit 341 may acquire the action history 213 of the customer U1, analyze the action history 213, and extract the interest information of the customer U1 regarding the information about the product which the customer U1 wants to try. Note that the store cooperation support apparatus 300 may hold in advance the action history 213 of each customer in the online store 2 or the interest information of each customer in regard to the respective products. In this case, the acquisition unit 341 reads the interest information held in the store cooperation support apparatus 300, thereby acquiring this information.

In response to the acquisition of the trial request, the selection unit 342 selects the second store from among a plurality of physical stores capable of physically selling a product which the costumer wants to try based on inventory information about the product in each physical store. Specifically, the selection unit 342 refers to the inventory information 3123 of the product information 3122 included in the trial request, and selects a physical store where the number of inventory products is greater than or equal to a predetermined number as the second store. Further, the selection unit 342 may select a physical store by using part of the interest information and the personal information of the customer acquired by the acquisition unit 341. For example, the selection unit 342 identifies the preferences of the customer such as a brand, a size, and a color included in the interest information among pieces of the product information included in the trial request. Then the selection unit 342 refers to the physical store inventory information 312 and selects a physical store that has an inventory of the product indicated by the product information and the product that satisfies the specified preferences. Note that when a plurality of physical stores are selected, the selection unit 342 may select any physical store from among them. Alternatively, when a plurality of physical stores are selected, the selection unit 342 may select a physical store by taking into account the personal information of the customer. For example, the selection unit 342 may select a physical store that is closer to the customer's address from among the plurality of physical stores selected. Alternatively, when a plurality of physical stores are selected, the selection unit 342 may select a physical store having a greater inventory of the product that satisfies the preferences of the customer than those of other physical stores.

The generation unit 343 generates disclosure information including personal information and interest information acquired by the acquisition unit 341. Note that the generation unit 343 may include part, but not all, of the personal information in the disclosure information. For example, when the product which the customer wants to try is clothing, the generation unit 343 may extract gender, an age group, height, and the like from the personal information 212 of the customer U1 and include them in the disclosure information.

The setting unit 344 is an example of the setting unit 12 described above and ID integration means. The setting unit 344 sets, based on date and time information included in the trial request, a disclosure period for disclosing disclosure information generated by the generation unit 343 to the physical store selected by the selection unit 342. For example, the setting unit 344 sets a date and time three hours or one week after the date and time indicated by the date and time information included in the trial request as a time limit of the disclosure period.

Further, in response to the acquisition of the trial request, the setting unit 344 associates the store ID of the selected physical store, a first customer ID of the customer in the online store, and the generated disclosure information with one another and stores them in the storage unit 310. Specifically, first, the setting unit 344 issues the integrated ID 3131 in response to the acquisition of the trial request. Then the setting unit 344 generates the integrated ID information 313 by associating the online store ID 3132 and the online store user ID 3133 included in the trial request and the physical store ID 3134 of the selected physical store with the integrated ID 3131. Further, the setting unit 344 associates the generated disclosure information 3136 and the set disclosure period 3137 with the integrated ID 3131 of the integrated ID information 313. Then the setting unit 344 stores the integrated ID information 313 in the storage unit 310.

After the integrated ID information 313 is generated or stored, the setting unit 344 transmits a trial reservation notification to the physical store server or the physical store terminal corresponding to the physical store ID 3134. At this time, the setting unit 344 includes at least the integrated ID 3131 in the trial reservation notification. Further, the setting unit 344 may include the disclosure information 3136 and the disclosure period 3137 in the trial reservation notification. Further, the setting unit 344 transmits, to the online store server 200 or the user terminal 100, a trial reservation notification including the integrated ID 3131, information about the selected physical store, and the date and time information.

The setting unit 344 periodically monitors the disclosure period 3137 of the integrated ID information 313 to determine whether or not the disclosure period 3137 has elapsed. When the disclosure period 3137 has elapsed, the setting unit 344 sets an invalid flag in the disclosure period 3137 and updates the integrated ID information 313. Alternatively, instead of setting an invalid flag, the setting unit 344 may delete the disclosure information 3136 associated with the disclosure period 3137 or delete the integrated ID information 313 itself. In other words, when the setting unit 344 does not receive payment information about the product paid for by the customer U1 from the second store within the disclosure period, it sets disclosure of the disclosure information 3136 so that it is stopped.

When the setting unit 344 receives payment information about the product paid for by the customer U1 from the second store within the disclosure period 3137, it updates the time limit of the disclosure period 3137 so that it is extended. For example, the setting unit 344 may extend the time limit of the disclosure period 3137 for one month. Alternatively, when the setting unit 344 receives payment information about the product paid for by the customer U1 from the second store within the disclosure period 3137, it may update the time limit of the disclosure period 3137 so that it is indefinite.

Further, when a second customer ID of the customer U1 in the second store has already been issued, the setting unit 344 associates the second customer ID with disclosure information and stores them in the storage unit 310. For example, it is assumed that the second store is the physical store 4, and the physical store 4 has already issued the user ID 421 for the customer U1. In this case, for example, the setting unit 344 receives a payment notification and the user ID 421 by which the payment has been made from the physical store terminal 41, and updates the integrated ID information 313 by associating the user ID 421 as the physical store user ID 3135 with the integrated ID 3131 and the disclosure information 3136.

Further, when the second customer ID of the customer U1 in the second store has not been issued, the setting unit 344 issues the second customer ID, and then associates the issued second customer ID with the disclosure information and stores them in the storage unit 310. For example, it is assumed that the setting unit 344 has received the payment notification from the physical store terminal 41 and has not acquired the user ID of the customer U1 who has made the payment. In this case, the setting unit 344 newly issues the user ID (the physical store user ID 3135) of the customer U1 for the physical store 4, and updates the integrated ID information 313 by associating the issued physical store user ID 3135 with the integrated ID 3131 and the disclosure information 3136.

Further, when the setting unit 344 acquires the sales history related to the customer U1 in the second store from the second store, the setting unit 344 associates the first customer ID with the sales history and stores them in the storage unit 310. For example, the setting unit 344 acquires from the physical store terminal 41 the sales history 423 related to customer U1 in the physical store 4, and updates the integrated ID information 313 by associating the online store user ID 3133 of the customer U1 with the sales history 423 (the physical store sales history 3138) (and the integrated ID 3131).

Further, when the setting unit 344 acquires disclosure restriction information about the sales history from the second store, it further associates the disclosure restriction information with the first customer ID and the sales history and stores them in the storage unit 310. For example, it is assumed that the setting unit 344 has received, from the physical store terminal 41, a specification of a disclosure range of the sales history 423 regarding the user ID 421. In this case, the setting unit 344 sets the specified disclosure range as the physical store sales history disclosure range 3139, and identifies the online store user ID 3133 corresponding to the specified user ID 421 (the physical store user ID 3135). Then the setting unit 344 updates the integrated ID information 313 by associating the physical store sales history disclosure range 3139, the online store user ID 3133, the physical store sales history 3138, and the integrated ID 3131 with one another.

When the disclosure unit 345 receives, from the second store, a disclosure request for disclosure information related to the trial request within the disclosure period, it sends the corresponding disclosure information. For example, it is assumed that the second store is the physical store 4. In this case, the disclosure unit 345 receives a disclosure request specifying the integrated ID from the physical store terminal 41. Then the disclosure unit 345 identifies the disclosure period 3137 associated with the specified integrated ID 3131 and determines whether or not the current time is within the disclosure period 3137. When the current time is within the disclosure period 3137, the disclosure unit 345 identifies the disclosure information 3136 associated with the integrated ID 3131 and transmits the identified disclosure information 3136 to the physical store terminal 41.

Further, when the disclosure unit 345 receives a disclosure request for information about the customer U1 from the first store, it discloses the sales history associated with the first customer ID to the first store. Specifically, the disclosure unit 345 receives, from the online store server 200, a disclosure request for the sales history in the physical store, which specifies the user ID 211 of the customer U1. In this case, the disclosure unit 345 identifies the physical store sales history 3138 associated with the specified user ID 211 (the online store user ID 3133), and transmits the identified physical store sales history 3138 to the store cooperation support apparatus 300. At this time, when the physical store sales history disclosure range 3139 associated with the online store user ID 3133 is present, the disclosure unit 345 generates second disclosure information within the range of the physical store sales history disclosure range 3139 in the identified physical store sales history 3138. Then the disclosure unit 345 transmits the generated second disclosure information to the store cooperation support apparatus 300. In other words, the disclosure unit 345 discloses information of the sales history which is restricted based on the disclosure restriction information to the first store.

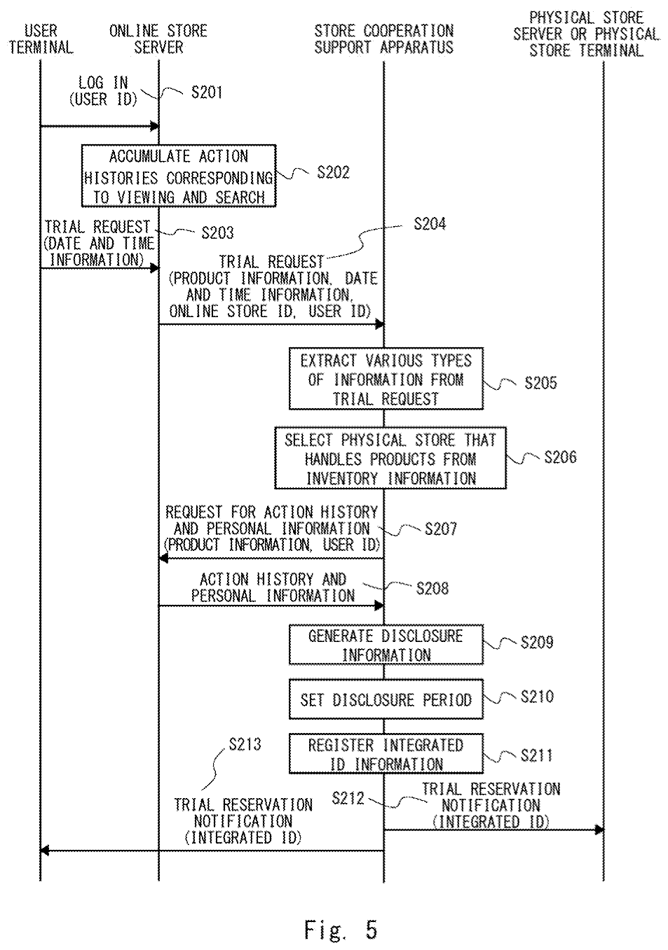

FIG. 5 is a sequence diagram showing a flow of trial reservation processing according to the second example embodiment. It is assumed here that customer U1 makes a trial reservation with a physical store for a product to be sold on the sales site of the online store server 200.

First, the user terminal 100 logs in to the online store server 200 by the operation performed by the customer U1 (S201). At this time, the user terminal 100 transmits the user ID, a password, and the like of the customer U1 in the online store 2 to the online store server 200 through the network N. In response to this transmission, the online store server 200 performs login processing of the customer U1 and displays the sales pages of various types of products on the user terminal 100. Then the customer U1 operates the user terminal 100 so as to, for example, search for various types of products and view the sales pages. At this time, the online store server 200 accumulates the action histories 213 corresponding to the viewing and the search (S202). That is, the online store server 200 acquires a search keyword included in a search request received from the user terminal 100 through the network N, product information included in the viewed sales pages, and the like as the action history of the customer U1. Then the online store server 200 associates the acquired action history 213 with the user ID 211 of the customer U1 and stores them in the customer information DB 210. Note that the personal information 212 of the customer U1 has been registered in advance in the customer information DB 210.

Next, it is assumed that the customer U1 has viewed the sales page of a certain product and wants to try this product in a physical store. On the sales page, for example, a date and time input field and a trial request button are displayed. Then, it is assumed that the customer U1 operates the user terminal 100 so as to enter the date and time when he/she wants to visit the physical store and try the product in the date and time input field, and presses the trial request button. At this time, the user terminal 100 transmits a trial request including the date and time information input in the date and time input field by the customer U1 to the online store server 200 through the network N (S203).

When the online store server 200 receives the trial request from the user terminal 100 through the network N, it transmits the trial request to the store cooperation support apparatus 300 through the network N (S204). At this time, the online store server 200 includes, in the trial request, requested product information corresponding to the sales page, the online store ID of the online store 2, the user ID of the logged-in customer U1, and the date and time information.

Then, the acquisition unit 341 of the store cooperation support apparatus 300 receives the trial request from the online store server 200 through the network N. Then the acquisition unit 341 extracts various types of information (the product information, the online store ID, the user ID, and the date and time information) from the received trial request (S205).

Next, the selection unit 342 selects a physical store that handles the product extracted in Step S205 from the physical store inventory information 312 (S206). Specifically, the selection unit 342 identifies a physical store where the inventory information 3123 of the extracted product information 3122 is equal to or greater than a predetermined number. When the number of identified physical stores is two or larger, the selection unit 342 may select a physical store having a larger/largest number of inventory products. Alternatively, after Step S208, which will be described later, the selection unit 342 may select a physical store having an assortment of products closer/closest to the interest information of the customer U1.

Further, the acquisition unit 341 transmits a request for an action history and personal information, including the product information and the user ID extracted in Step S205, to the online store server 200 through the network N (S207). The online store server 200 reads the personal information 212 and the action history 213 associated with the user ID 211 included in the received request from the customer information DB 210, and transmits the personal information 212 and the action history 213 to the store cooperation support apparatus 300 through the network N (S208). At this time, the online store server 200 may extract an action history related to the product information included in the request from the action histories 213 and transmit the extracted action history. Alternatively, the online store server 200 may analyze the extracted action history to thereby generate interest information, and then transmits the generated interest information.

The acquisition unit 341 receives the personal information and the action history or the interest information of the customer U1 from the online store server 200 through the network N. Then the acquisition unit 341 analyzes the action history as necessary to thereby generate interest information of the customer U1 about the product. Then the generation unit 343 generates disclosure information including the personal information and the interest information (S209).

Further, the setting unit 344 sets a disclosure period based on the date and time information extracted in Step S205 (S210). For example, the setting unit 344 sets a date and time after a predetermined period from the date and time indicated by the date and time information as the time limit of the start period.

After that, the setting unit 344 registers the integrated ID information 313 (S211). For example, the setting unit 344 issues a new integrated ID 3131. Then the setting unit 344 generates the integrated ID information 313 by associating the online store ID 3132 extracted in Step S205, the online store user ID 3133, and the physical store ID 3134 selected in Step S206 with the integrated ID 3131. Further, the setting unit 344 updates the integrated ID information 313 by associating the disclosure information 3136 generated in Step S209 and the disclosure period 3137 set in Step S210 with the integrated ID 3131. Then the setting unit 344 stores the generated and updated integrated ID information 313 in the storage unit 310.

After that, the setting unit 344 transmits a trial reservation notification including at least the integrated ID 3131 to the physical store server or the physical store terminal corresponding to the physical store ID 3134 through the network N (S212). Further, the setting unit 344 transmits a trial reservation notification including at least the integrated ID 3131, information about the selected physical store, and the date and time information to the user terminal 100 corresponding to the online store user ID 3133 through the network N (S213). Note that the setting unit 344 may transmit a trial reservation notification to a customer to the online store server 200, and the user terminal 100 may refer to the trial reservation notification through the online store server 200.

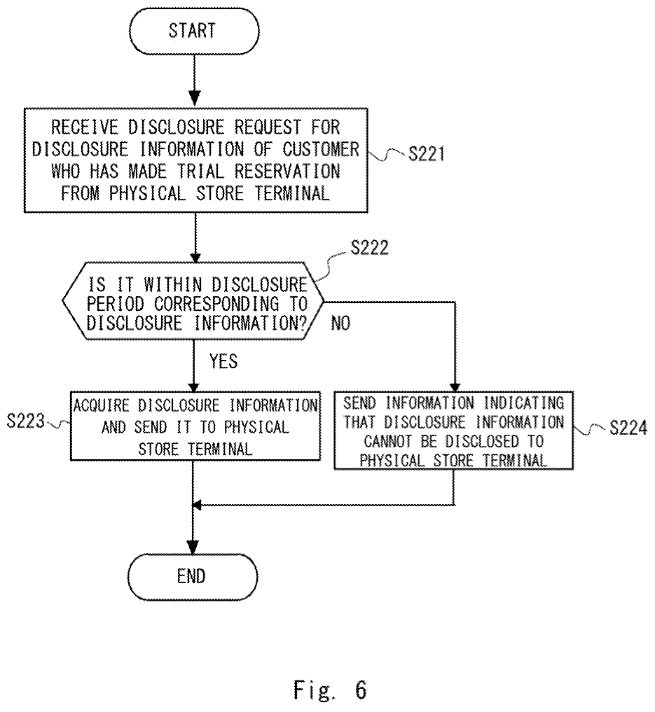

FIG. 6 is a flowchart showing a flow of processing for disclosing disclosure information according to the second example embodiment. It is assumed that the physical store terminal 41 has already received the above-described trial reservation notification (through the physical store server 42 as necessary). Then, the physical store terminal 41 transmits a disclosure request specifying the integrated ID 3131 included in the trial reservation notification in response to an operation performed by the store clerk U4. The disclosure request is a request for disclosure of disclosure information of a customer who has made a trial reservation.

In response to the above transmission, the disclosure unit 345 of the store cooperation support apparatus 300 receives, from the physical store terminal 41, a disclosure request for the disclosure information of the customer who has made a trial reservation through the network N (S221). Then the disclosure unit 345 determines whether or not it is within a disclosure period corresponding to the disclosure information (S222). Specifically, the disclosure unit 345 refers to the storage unit 310 and then identifies the disclosure period 3137 that is associated with the integrated ID 3131 specified in the disclosure request. Then the disclosure unit 345 determines whether or not the current time is within the specified disclosure period 3137.

When it is determined in Step S222 that it is within the disclosure period, the disclosure unit 345 acquires, from the storage unit 310, the disclosure information 3136 that is associated with the integrated ID 3131 specified in the disclosure request. Then the disclosure unit 345 sends, through the network N, the disclosure information 3136 to the physical store terminal 41 which has transmitted the disclosure request (S223). By doing so, the physical store terminal 41 can display the disclosure information 3136 received from the store cooperation support apparatus 300 on the screen. Thus, the store clerk U4 can view the disclosure information of the customer who has made a trial reservation through the physical store terminal 41.

On the other hand, when it is determined in Step S222 that it is not within the disclosure period, the disclosure unit 345 sends, through the network N, information indicating that the disclosure information cannot be disclosed to the physical store terminal 41 which has transmitted the disclosure request (S224). For example, when an invalid flag is set in the disclosure period 3137 that is associated with the integrated ID 3131 specified in the disclosure request, the disclosure unit 345 determines that it is not within the disclosure period. By doing so, the physical store terminal 41 can display the information indicating that the disclosure information cannot be disclosed received from the store cooperation support apparatus 300 on the screen. Therefore, when the disclosure period has elapsed, the store clerk U4 cannot check interest information or personal information of a customer even when this customer is a customer who has made a trial reservation. Thus, it is possible to appropriately manage customer information.

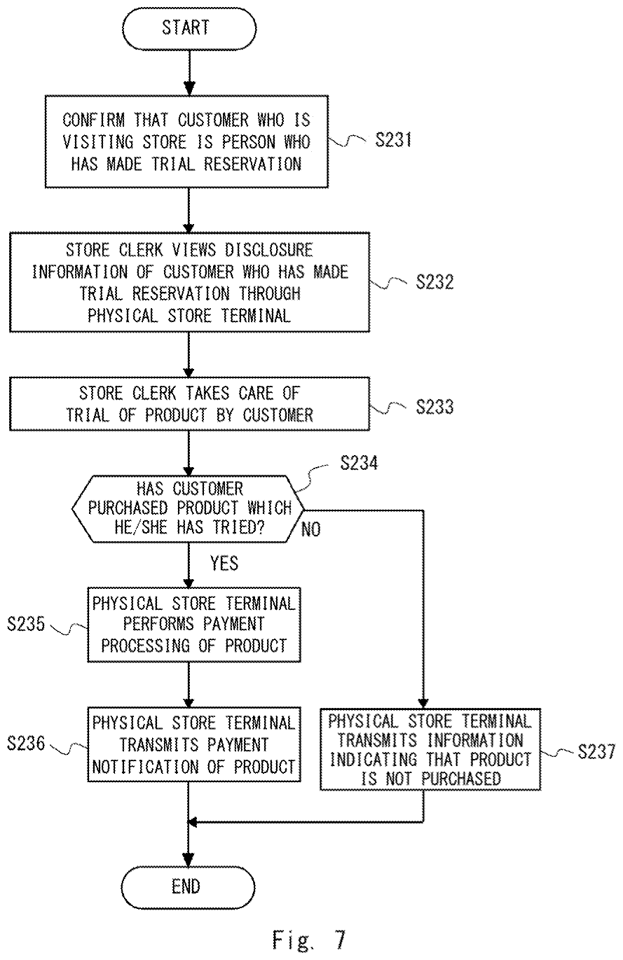

FIG. 7 is a flowchart showing a flow of processing performed by a store when a customer who has made a trial reservation visits the store according to the second example embodiment. For example, it is assumed that the customer U1 has already made a trial reservation with the physical store 4 by the processing shown in FIG. 5. Further, it is assumed that the customer U1 is visiting the physical store 4. For example, the customer U1 displays information about a trial reservation (including the integrated ID 3131 etc.) that has transmitted in Step S213 on the screen of the user terminal 100. Then the customer U1 shows the store clerk U4 the information about a trial reservation displayed on the user terminal 100. In response to this, the store clerk U4 confirms that the customer U1 who is visiting the store is a person who has made a reservation for use (S231).

Then, the store clerk U4 views the disclosure information of the customer who has made a trial reservation through the physical store terminal 41 (S232). At this time, the physical store terminal 41 may transmit the disclosure request including the integrated ID 3131 displayed on the user terminal 100 to the store cooperation support apparatus 300, acquire disclosure information as shown in FIG. 6, and display the disclosure information on the screen.

Then, the store clerk U4 takes care of a trial of the product by the customer U1 while referring to the disclosure information (S233). For example, when the product is clothing, the store clerk U4 may, based on the disclosure information, select clothing of a brand, a size, and a color that match the preferences of the customer U1 and then encourage the customer U1 to try it on.

After that, when the customer U1 purchases the product which he/she has tried (YES in S234), the physical store terminal 41 performs payment processing of the product in response to an operation performed by the store clerk U4 (S235). Then the physical store terminal 41 transmits a payment notification of the product to the store cooperation support apparatus 300 through the network N (S236). At this time, the physical store terminal 41 includes, in the payment notification, at least the integrated ID 3131 and the fact that the payment has been made. Further, the physical store terminal 41 may include a sales history associated with the payment processing in the payment notification. The sales history may include whether or not a credit card is used for making the payment, the amount of the payment, the product information, the date and time of the payment, and the like. Note that when the user ID 421 of the customer U1 has already been issued (or newly issued) in the physical store 4, the physical store terminal 41 may include the user ID 421 in the payment notification. Then the physical store terminal 41 associates the issued user ID 421 with the sales history 423 and registers them in the customer information DB 420. At this time, the physical store terminal 41 may further associate the personal information 422 of the customer U1 with the user ID 421 and register them in the customer information DB 420.

On the other hand, when the customer U1 leaves the store without purchasing the product which he/she has tried (NO in S234), the physical store terminal 41 transmits information indicating that the product is not purchased to the store cooperation support apparatus 300 through the network N (S237).

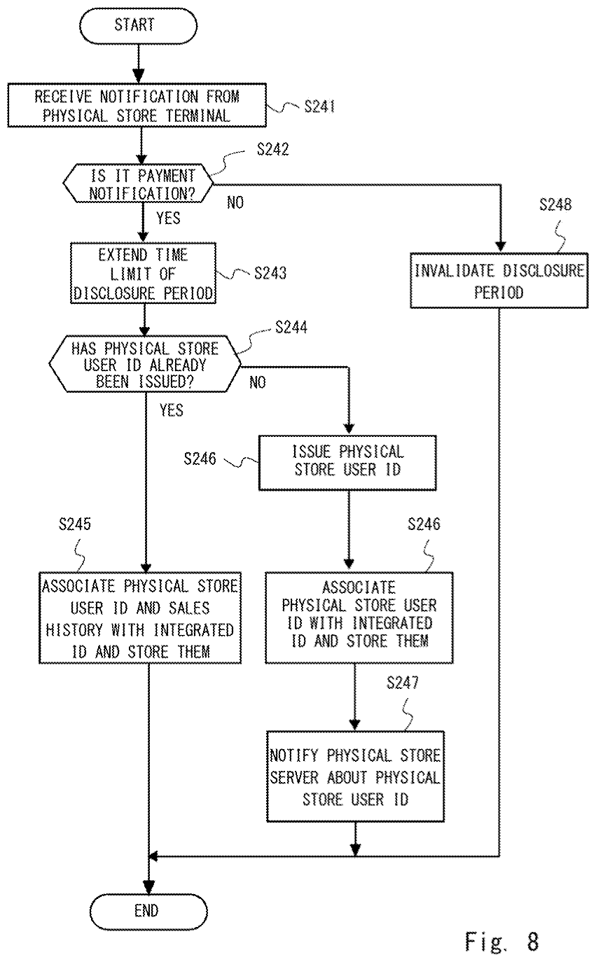

FIG. 8 is a flowchart showing a flow of processing for updating integrated ID information when a customer visits a store according to the second example embodiment. The processing following the processing shown in FIG. 7 performed by the store cooperation support apparatus 300 will be described below. First, the setting unit 344 of the store cooperation support apparatus 300 receives a predetermined notification from the physical store terminal 41 through the network N (S241). Next, the setting unit 344 determines whether or not the received notification is a payment notification (S242). When the received notification is the above-described payment notification in Step S236 in FIG. 7, the setting unit 344 extends the time limit of the disclosure period (S234). For example, the setting unit 344 identifies the disclosure period 3137 that is associated with the integrated ID 3131 included in the payment notification and updates the time limit of the disclosure period 3137 so that it is extended for one month.

Then, the setting unit 344 determines whether or not the physical store user ID has already been issued (S244). For example, when the received payment notification includes the physical store user ID (the user ID 421), the setting unit 344 determines that the physical store user ID has already been issued. Further, in this case, the received payment notification also includes the sales history. Accordingly, the setting unit 344 sets the user ID 421 as the physical store user ID 3135. Then the setting unit 344 updates the integrated ID information 313 by associating the physical store user ID 3135 and the sales history (the physical store sales history 3138) included in the payment notification with the integrated ID 3131 included in the payment notification and stores the updated information in the storage unit 310 (S245). In this way, the physical store user ID 3135 is associated with the disclosure information 3136 including the interest information of the customer U1.

On the other hand, when the physical store user ID has not been issued in Step S244, the setting unit 344 issues a new physical store user ID for the customer U1 (S246). For example, when the physical store user ID is not included in the received payment notification or when the physical store user ID 3135 is not associated with the integrated ID 3131 included in the received payment notification, the setting unit 344 determines that the physical store user ID has not been issued.

After Step S246, the setting unit 344 updates the integrated ID information 313 by associating the issued physical store user ID 3135 with the integrated ID 3131 included in the payment notification and stores the updated information in the storage unit 310 (S246). Note that even when the payment notification does not include the physical store user ID but includes the sales history, the setting unit 344 may further associate the physical store sales history 3138 with the integrated ID 3131 like in Step S245.

Then, the setting unit 344 notifies the physical store server 42 about the issued physical store user ID (S247). In response to this notification, the physical store server 42 associates the received physical store user ID as the user ID 421 with the sales history 423 and stores them in the customer information DB 420. Note that Steps S246 and S247 may be executed in parallel.

In Step S242, when the received notification is the above-described notification indicating that the product is not purchased in Step S237 of FIG. 7, the setting unit 344 invalidates the disclosure period (S248). For example, the setting unit 344 sets an invalid flag in the disclosure period 3137 associated with the integrated ID 3131 included in the payment notification. Alternatively, the setting unit 344 may delete from the storage unit 310 the integrated ID information 313 corresponding to the integrated ID 3131 included in the payment notification.

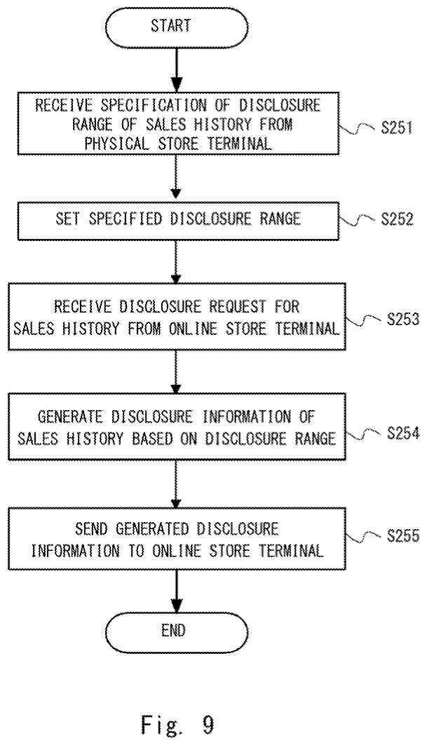

FIG. 9 is a flowchart showing a flow of processing for disclosing a sales history according to the second example embodiment. It is assumed here that, in the store cooperation support apparatus 300, the physical store sales history 3138 is associated with the integrated ID information 313 and is registered.

First, in response to an operation performed by the store clerk U4, the physical store terminal 41 transmits a specification of a disclosure range of the sales history of the customer U1 in the physical store 4 to be disclosed to the online store 2 to the store cooperation support apparatus 300 through the network N. Note that the disclosure range of the sales history in the physical stores 4 is disclosure restriction information about the sales history. At this time, the physical store terminal 41 also transmits the physical store ID of the physical store 4 and the user ID 421 of the customer U1. Further, the physical store terminal 41 may transmit the sales history 423 whose disclosure is to be restricted.

In response to the above transmission, the setting unit 344 of the store cooperation support apparatus 300 receives the specification of the disclosure range of the sales history from the physical store terminal 41 through the network N (S251). In addition, the setting unit 344 receives the physical store ID of the physical store 4 and the physical store user ID of the customer U1. Then the setting unit 344 sets the specified disclosure range (S252). Specifically, the setting unit 344 updates the integrated ID information 313 by associating the specified disclosure range (the physical store sales history disclosure range 3139) with the received physical store user ID 3135.

After that, the disclosure unit 345 receives a disclosure request for the sales history of the customer U1 in the physical store from a store terminal (not shown) of the online store 2 (or the online store server 200) (S253). Note that the disclosure request includes the store ID of the online store 2 and the user ID 211 of the customer U1.

Therefore, the disclosure unit 345 identifies, from the integrated ID information 313, the physical store sales history 3138 and the physical store sales history disclosure range 3139 associated with the user ID 211 (the online store user ID 3133) included in the received disclosure request. Then the disclosure unit 345 generates disclosure information of the physical store sales history 3138 based on the specified physical store sales history disclosure range 3139 (S254). For example, when the physical store sales history 3138 includes credit card information used for making the payment, the disclosure unit 345 generates disclosure information by masking the credit card information or while leaving only the fact that it was payment simply made using a credit card. Alternatively, the disclosure unit 345 may generate disclosure information by converting a specific product name in the physical store sales history 3138 into a product genre or the like.

After that, the disclosure unit 345 sends the generated disclosure information to the store terminal of the online store 2 which is the request source (S255). Accordingly, the store terminal of the online store 2 displays the received disclosure information on the screen. Thus, a store clerk of the online store 2 can refer to the sales history of the customer U1 of the online store 2 in the physical store 4. Therefore, it can be used for marketing in the online store 2. Further, the range of the sales history (the disclosure information) to be disclosed is restricted by the physical store 4. Therefore, the physical store 4 can appropriately manage the customer information of the physical store 4.

As described above, this example embodiment can support for taking a customer who finds a product in an online store to a physical store where the customer actually can try the product. When doing so, the store cooperation support apparatus 300 discloses interest information of the customer about the product in the online store and personal information to the physical store within a disclosure period corresponding to the date and time at which the customer wants to visit the physical store. Thus, it is possible to perform control so that disclosure information is disclosed within an appropriate period of time. Therefore, the online store can feel a sense of security when it discloses customer information to the physical store, and cooperation between the online store and the physical store is promoted. Further, the physical store can provide an incentive to the online store by disclosing the sales history in the physical store to the online store. When doing so, the physical store can control the contents and the like of the sales history to be disclosed. This will further promote the cooperation between the stores.

### <Other Example Embodiments>

Note that although the present disclosure has been described as a hardware configuration in the above example embodiments, the present disclosure is not limited thereto. In the present disclosure, any processing can also be implemented by causing a CPU to execute a computer program.

In the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Read Only Memory), CD-R, CD-R/W, DVD (Digital Versatile Disc), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present disclosure is not limited to the above-described example embodiments and may be changed as appropriate without departing from the scope and spirit of the present disclosure. Further, the present disclosure may be executed by combining the example embodiments with one another as appropriate.

The whole or part of the example embodiments disclosed above can be described as, but not limited to, the following supplementary notes.

### (Supplementary Note A1)

A store cooperation support apparatus comprising:

acquisition means for acquiring, through a sales site of a first store capable of selling a predetermined product online, a trial request including date and time information indicating a date and time at which a predetermined customer wants to try the product in a physical store; and

setting means for setting a disclosure period for disclosing, based on the date and time information, disclosure information including interest information of the customer about the product in the first store to a second store capable of physically selling the product.

### (Supplementary Note A2)

The store cooperation support apparatus according to Supplementary note A1, wherein

the acquisition means acquires personal information of the customer in the first store and the interest information through the sales site, and

the store cooperation support apparatus further comprises generation means for generating the disclosure information including the acquired personal information and interest information.

### (Supplementary Note A3)

The store cooperation support apparatus according to Supplementary note A1 or A2, wherein when the setting means receives payment information about the product paid for by the customer from the second store within the disclosure period, the setting means updates a time limit of the disclosure period so that it is extended.

(Supplementary Note A4) The store cooperation support apparatus according to Supplementary note A1 or A2, wherein when the setting means receives payment information about the product paid for by the customer from the second store within the disclosure period, the setting means updates a time limit of the disclosure period so that it is indefinite.

### (Supplementary Note A5)

The store cooperation support apparatus according to any one of Supplementary notes A1 to A4, wherein when the setting means does not receive payment information about the product paid for by the customer from the second store within the disclosure period, the setting means sets disclosure of the disclosure information so that it is stopped.

### (Supplementary Note A6)

The store cooperation support apparatus according to any one of Supplementary notes A1 to A5, further comprising ID integration means for, in response to the acquisition of the trial request, associating a store ID of the second store, a first customer ID of the customer in the first store, and the disclosure information with one another and storing them in storage means.

### (Supplementary Note A7)

The store cooperation support apparatus according to Supplementary note A6, wherein

when a second customer ID of the customer in the second store has already been issued, the ID integration means associates the second customer ID with the disclosure information and stores them in the storage means, and

when a second customer ID of the customer in the second store has not been issued, the ID integration means issues the second customer ID, and then associates the issued second customer ID with the disclosure information and stores them in the storage means.

### (Supplementary Note A8)

The store cooperation support apparatus according to Supplementary note A6 or A7, wherein

when the ID integration means acquires a sales history related to the customer in the second store from the second store, the ID integration means associates the first customer ID with the sales history and stores them in the storage means, and

the store cooperation support apparatus further comprises disclosure means for disclosing the sales history associated with the first customer ID to the first store when a request for disclosure of information about the customer is received from the first store.

### (Supplementary Note A9)

The store cooperation support apparatus according to Supplementary note A8, wherein

when the ID integration means acquires disclosure restriction information about the sales history from the second store, the ID integration means further associates the disclosure restriction information with the first customer ID and the sales history and stores them in the storage means, and

the disclosure means discloses information of the sales history which is restricted based on the disclosure restriction information to the first store.

### (Supplementary Note A10)

The store cooperation support apparatus according to any one of

Supplementary notes A1 to A9, further comprising selection means for selecting, from among a plurality of physical stores capable of physically selling the product, the second store based on inventory information about the product in each of the physical stores in response to the acquisition of the trial request.

### (Supplementary Note B1)

A store cooperation support system comprising:

a first store server configured to provide a sales site of a first store capable of selling a predetermined product online;

a store terminal in a second store capable of physically selling the product; and

a store cooperation support apparatus, wherein

the store cooperation support apparatus comprises:

acquisition means for acquiring, through the sales site, a trial request including date and time information indicating a date and time at which a predetermined customer wants to try the product in a physical store; and

setting means for setting a disclosure period for disclosing, based on the date and time information, disclosure information including interest information of the customer about the product in the first store to the store terminal in the second store.

### (Supplementary Note B2)

The store cooperation support system according to Supplementary note B1, wherein

the acquisition means acquires personal information of the customer in the first store and the interest information through the sales site, and

the store cooperation support system further comprises generation means for generating the disclosure information including the acquired personal information and interest information.

### (Supplementary Note C1)

A store cooperation support method comprising:

acquiring by a computer, through a sales site of a first store capable of selling a predetermined product online, a trial request including date and time information indicating a date and time at which a predetermined customer wants to try the product in a physical store; and

setting by the computer a disclosure period for disclosing, based on the date and time information, disclosure information including interest information of the customer about the product in the first store to a second store capable of physically selling the product.

### (Supplementary Note D1)

A non-transitory computer readable medium storing a store cooperation support program for causing a computer to execute:

an acquisition process of acquiring, through a sales site of a first store capable of selling a predetermined product online, a trial request including date and time information indicating a date and time at which a predetermined customer wants to try the product in a physical store; and

a setting process of setting a disclosure period for disclosing, based on the date and time information, disclosure information including interest information of the customer about the product in the first store to a second store capable of physically selling the product.

Although the present invention has been described with reference to the example embodiments (and the examples), the present invention is not limited to the above-described example embodiments (and the examples). Various changes that may be understood by those skilled in the art may be made to the configurations and details of the present invention within the scope of the present invention.

### REFERENCE SIGNS LIST

1 STORE COOPERATION SUPPORT APPARATUS
11 ACQUISITION UNIT
12 SETTING UNIT
1000 STORE COOPERATION SUPPORT SYSTEM
100 USER TERMINAL
2 ONLINE STORE
200 ONLINE STORE SERVER
210 CUSTOMER INFORMATION DB
211 USER ID
212 PERSONAL INFORMATION
213 ACTION HISTORY
300 STORE COOPERATION SUPPORT APPARATUS
310 STORAGE UNIT
311 PROGRAM
312 PHYSICAL STORE INVENTORY INFORMATION
3121 PHYSICAL STORE ID
3122 PRODUCT INFORMATION
3123 INVENTORY INFORMATION
313 INTEGRATED ID INFORMATION
3131 INTEGRATED ID
3132 ONLINE STORE ID
3133 ONLINE STORE USER ID
3134 PHYSICAL STORE ID
3135 PHYSICAL STORE USER ID
3136 DISCLOSURE INFORMATION
3137 DISCLOSURE PERIOD
3138 PHYSICAL STORE SALES HISTORY
3139 PHYSICAL STORE SALES HISTORY DISCLOSURE RANGE
320 MEMORY
330 IF UNIT
340 CONTROL UNIT
341 ACQUISITION UNIT
342 SELECTION UNIT
343 GENERATION UNIT
344 SETTING UNIT
345 DISCLOSURE UNIT
4 PHYSICAL STORE
41 PHYSICAL STORE TERMINAL
42 PHYSICAL STORE SERVER
420 CUSTOMER INFORMATION DB
421 USER ID
422 PERSONAL INFORMATION
423 SALES HISTORY
5 PHYSICAL STORE
51 PHYSICAL STORE TERMINAL
52 PHYSICAL STORE SERVER
520 CUSTOMER INFORMATION DB
521 USER ID
522 PERSONAL INFORMATION
523 SALES HISTORY
N NETWORK
U1 CUSTOMER
U4 STORE CLERK
U5 STORE CLERK

What is claimed is:

1. A store cooperation support apparatus comprising:
at least one storage device configured to store instructions; and
at least one processor configured to execute the instructions to:
acquire, through a sales site of a first store capable of selling a predetermined product online, a trial request including date and time information indicating a date and time at which a predetermined customer wants to try the product in a physical store; and
set a disclosure period for disclosing, based on the date and time information, disclosure information including interest information of the customer about the product in the first store to a second store capable of physically selling the product.

2. The store cooperation support apparatus according to claim 1, wherein the at least one processor is further configured to execute the instructions to:
acquire personal information of the customer in the first store and the interest information through the sales site, and
generate the disclosure information including the acquired personal information and interest information.

3. The store cooperation support apparatus according to claim 1, wherein the at least one processor is further configured to execute the instructions to:
when the store cooperation support apparatus receives payment information about the product paid for by the customer from the second store within the disclosure period, update a time limit of the disclosure period so that it is extended.

4. The store cooperation support apparatus according to claim 1, wherein the at least one processor is further configured to execute the instructions to:
when the store cooperation support apparatus receives payment information about the product paid for by the customer from the second store within the disclosure period, update a time limit of the disclosure period so that it is indefinite.

5. The store cooperation support apparatus according to claim 1, wherein the at least one processor is further configured to execute the instructions to:
when the store cooperation support apparatus does not receive payment information about the product paid for by the customer from the second store within the disclosure period, set disclosure of the disclosure information so that it is stopped.

6. The store cooperation support apparatus according to claim 1, wherein the at least one processor is further configured to execute the instructions to:
in response to the acquisition of the trial request, associate a store ID of the second store, a first customer ID of the customer in the first store, and the disclosure information with one another and store them in the at least one storage device.

7. The store cooperation support apparatus according to claim 6, wherein the at least one processor is further configured to execute the instructions to:
when a second customer ID of the customer in the second store has already been issued, associate the second customer ID with the disclosure information and store them in the at least one storage device, and
when a second customer ID of the customer in the second store has not been issued, issue the second customer ID, and then associate the issued second customer ID with the disclosure information and store them in the at least one storage device.

8. The store cooperation support apparatus according to claim 6, wherein the at least one processor is further configured to execute the instructions to:
when the store cooperation support apparatus acquires a sales history related to the customer in the second store from the second store, associate the first customer ID with the sales history and store them in the at least one storage device, and
disclose the sales history associated with the first customer ID to the first store when a request for disclosure of information about the customer is received from the first store.

9. The store cooperation support apparatus according to claim 8, wherein the at least one processor is further configured to execute the instructions to:
when the store cooperation support apparatus acquires disclosure restriction information about the sales history from the second store, associate the disclosure restriction information with the first customer ID and the sales history and store them in the at least one storage device, and
disclose information of the sales history which is restricted based on the disclosure restriction information to the first store.

10. The store cooperation support apparatus according to claim 1, wherein the at least one processor is further configured to execute the instructions to:
select, from among a plurality of physical stores capable of physically selling the product, the second store based on inventory information about the product in each of the physical stores in response to the acquisition of the trial request.

11. A store cooperation support system comprising:
a first store server configured to provide a sales site of a first store capable of selling a predetermined product online;
a store terminal in a second store capable of physically selling the product; and
a store cooperation support apparatus, wherein
the store cooperation support apparatus comprises:
at least one storage device configured to store instructions; and
at least one processor configured to execute the instructions to:
acquire, through the sales site, a trial request including date and time information indicating a date and time at which a predetermined customer wants to try the product in a physical store; and
set a disclosure period for disclosing, based on the date and time information, disclosure information including interest information of the customer about the product in the first store to the store terminal in the second store.

12. The store cooperation support system according to claim 11, wherein the at least one processor is further configured to execute the instructions to:
acquire personal information of the customer in the first store and the interest information through the sales site, and
generate the disclosure information including the acquired personal information and interest information.

13.-14. (canceled)
